(19) United States
(12) Patent Application Publication
(10) Pub. No.: US 2012/0166348 A1
(43) Pub. Date: Jun. 28, 2012

(54) STATISTICAL ANALYSIS OF DATA RECORDS FOR AUTOMATIC DETERMINATION OF ACTIVITY OF NON-CUSTOMERS

(75) Inventors: Kirill Dyagilev, Haifa (IL); Yossi Richter, Kfar Saba (IL); Amir Ronen, Haifa (IL); Elad Yom-Tov, Hamovil (IL)

(73) Assignee: International Business Machines Corporation, Armonk, NY (US)

(21) Appl. No.: 12/978,564

(22) Filed: Dec. 26, 2010

(51) Int. Cl. G06Q 10/00; G06Q 99/00

(52) U.S. Cl. 705/319; 705/1.1

(57) ABSTRACT

Data records of a service provider may be utilized to estimate data regarding to users who are customers of an alternative service provider, such as a competitor. The data records may indicate interaction between users. An estimated value of a selected user may be determined based on a statistical model. The statistical model may be built using training data. The statistical model may take into account social activity of the selected user, such as which users are socially proximate to him. The statistical model may take into account interactions of the selected user with users who are customers of the service provider. The statistical model may take into account demographic data. The statistical model may take into account data regarding users who are socially proximate to the selected user.

### BACKGROUND

The present disclosure relates to statistical analysis, in general, and to automatic estimation of properties of non-customers of a provider, based on their activity as reflected in the data records of the provider, in particular.

Many service providers, such as telecommunication service providers in general, and mobile telecommunication service providers in particular, gather diverse statistical information about an individual customer in order to predict his behavior, needs, requirements and the like.

When the service provider wants to acquire customers of a competitor, the service provider would like to have an estimate as to the value of the acquired customers. The value may be measured based on revenue/profit generated by the acquired customers, by interactions associated with them (e.g., other customers calling them), by other customers that would follow them into becoming customers of the service provider and their respective value, and the like.

However, the service provider does not have any particular information of the customers of its competitor. The provider, therefore, is unable to estimate objectively the competitor's customer's value.

Although the present disclosure discusses in detail customers of telecommunication services, it should be noted that the disclosed subject matter is not limited to such services. The disclosed subject matter may be utilized for any type of service in which customer to customer interactions are observed.

### BRIEF SUMMARY OF THE INVENTION

One exemplary embodiment of the disclosed subject matter is a computer-implemented method performed by a computerized device, the method comprising: obtaining data records from a service provider, each data record is indicative of an interaction between at least two users, wherein at least one of the at least two users is a customer of the service provider; selecting a user, the user is a customer of an alternative service provider; estimating, based on a portion of the data records that is associated with the selected user and based on a statistical model, an estimated value of an activity-related parameter associated with the selected user.

Another exemplary embodiment of the disclosed subject matter is a computerized apparatus having a processing unit and a memory device, the computerized system comprising: a data obtainer operative to obtain data records, each data record is indicative of an interaction between at least two users, wherein at least one of the at least two users is a customer of the service provider; a user selector operative to select a user, is the selected user is a customer of an alternative service provider; and an estimation module operative to estimate, based on a portion of the data records that is associated with the user and based on a statistical model, an estimated value of an activity-related parameter associated with the selected user.

Yet another exemplary embodiment of the disclosed subject matter is a computer program product comprising: a non-transitory computer readable medium; a first program instruction for obtaining data records from a service provider, each data record is indicative of an interaction between at least two users, wherein at least one of the at least two users is a customer of the service provider; a second program instruction for selecting a user, the user is a customer of an alternative service provider; a third program instruction for estimating, based on a portion of the data records that is associated with the selected user and based on a statistical model, an estimated value of an activity-related parameter associated with the selected user; and wherein the first, second, and third program instructions are stored on the non-transitory computer readable media.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a diagram of interaction between various service providers' users, in accordance with some exemplary embodiments of the disclosed subject matter;

FIG. 3 shows a block diagram of an apparatus, in accordance with some exemplary embodiments of the disclosed subject matter; and

FIG. 4 shows a flowchart diagram of a method, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to estimate value of acquiring a user who is not a customer of the service provider, but rather is a customer of an alternative service provider, such as a competitor. Another technical problem is to estimate the value of the user using the data records of the service provider, which provide a partial view of the user's interaction.

One technical solution is to estimate, based on the service provider's data records, and based on a statistical model, an estimated value of a user. Another technical solution is to use the service provider's data records to determine a social network of the user. The social network comprises users that interact with each other directly or indirectly. The social network comprises users that may be customers or non-customers of the service provider. Based on the information available of the users in the social network, an estimate as to the value of acquiring the user may be determined or a value of another activity-related parameter of the user. Yet another technical solution is to build the statistical model based on training data, such as historic data or portions of the data of the service provider. The statistical model may be validated and optionally updated, to improve it.

One technical effect of utilizing the disclosed subject matter is to induce information regarding non-customers of the service provider. Using a partial view of the non-customers' activity, as is described by the service provider's data records, a coherent estimation of value-relevant properties may be performed. Another effect is to enable better utilization of marketing resources by focusing on potential customers having a relatively estimated high value.

In the present application, a “user” is any entity capable of interacting with other entities (i.e., users) using the services of either the service provider or alternative service providers. In some exemplary embodiments, the user may use a cellular phone, a telephone, an email account, or the like to interact with the other users.

In the present application, a “customer” is a user which interacts with other users using the service provider. In other words the service provider providers the customer with services enabling him to interact with others. A customer may be a child using a mobile phone, as opposed to his parent that may pay for the services rendered. A customer may not pay the service provider at all, be obliged through a contract or through some other means, or the like. The customer is generally anyone that uses the service provider's services directly.

In the present application, a “non-customer” is a user that uses an alternative service provider to interact with users. The non-customer may interact with customers. In some exemplary embodiments, there may be a user which has two accounts, and therefore is considered both as a customer and a non-customer. In some exemplary embodiments, the two users may be induced to be similar using their social networks. In some exemplary embodiments, the two users are considered as separate and the fact that they are indeed the same entity is ignored.

Herein below, the disclosed subject matter is explained in particularity regarding an economical value of a user, which is based on the activity of the user and his socially proximate users. However, the disclosed subject matter is not limited to estimation of this parameter. Any parameter that is associated with the user's activity or the activity of the other users connected to the user (hereinafter “activity-related parameter associated with the user”) may be estimated. Some non-exhaustive examples of such parameters are: economical value of acquiring the user, a volume of calls utilized by the user, a bandwidth utilization, consumption of specific services (e.g., browsing, texting, or the like), or the like.

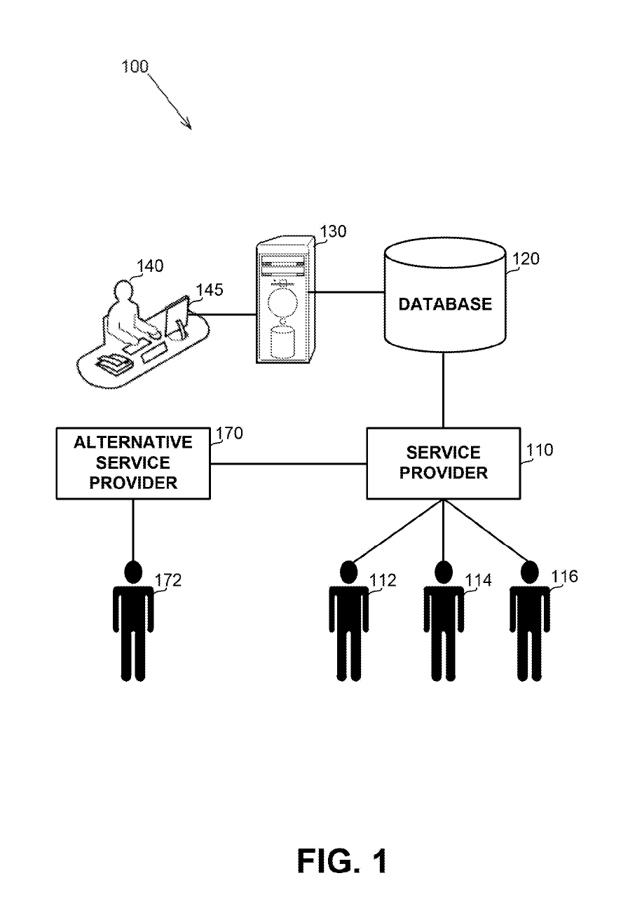

Referring now to FIG. 1 showing a computerized environment in which the disclosed subject matter is used, in accordance with some exemplary embodiments of the subject matter.

A computerized environment 100 may comprise a service provider 110, such as a telecommunication service provider, providing a service to customers 112, 114, 116. It will be noted that the service provider 110 may provide the service to many customers, such as thousands or millions of customers. It will be further noted that the service provider 110 may provide several types of specific services, such as a message communication, such as a Short Message Service (SMS), e-mail service and the like, a voice communication, such as a telephone call, Voice Over IP (VOIP) service and the like, a data communication service such as an TCP/IP connection, Wireless Application Protocol (WAP) connection and the like, or other services that enable a customer to interact with another user using a machine, device, telecommunication apparatus or the like. A user may be a person, a machine such as for example an automated answering service, a computerized server, a device and the like.

A customer, such as the customer 112, receives a service provided by the service provider 110. It will be noted that in some exemplary embodiments, a first customer, such as customer 112, may receive a service, such as a telecommunication service, with a user, such as non-customer 172, who is not a customer of the service provider 110. For example, a customer of the service provider may initiate a telephone call to a person who receives his telecommunication services from the alternative service provider 170.

The environment 100 may further comprise a database 120. The database 120 may store data records relating to a service provided by the service provider 110. A data record of the database 120 comprises information regarding an interaction between at least a customer and another user. In an exemplary embodiment, the data record comprises information regarding an interaction between two or more customers, such as customers 112 and 114. For example, the data record may comprise information regarding a phone call such as for example, time of call, date of call, call duration, a customer initiation the call, one or more customers receiving the call and the like. In an alternative example, the data record may comprise information regarding an SMS message such as for example, message sending time, message arrival time, message content, a customer sending the message, one or more customers receiving the message and the like. In some exemplary embodiments of the disclosed subject matter, the database 120 is managed mainly for billing purposes or business intelligence purposes. The database 120 may be a Call Detail Record (CDR) database of the service provider 110. The CDR database may comprise CDRs. A CDR may be descriptive of interactions of customers of the service provider 110. The CDR may indicate the participants of the interaction, the initiating participant(s), which of the participants is a customer and which is a non-customer. The CDR may further include location data of the participants, billing data, or the like.

In some exemplary embodiments of the disclosed subject matter, the environment further comprises an apparatus 130. The apparatus 130, such as a computerized server, may have access to the database 120. In some exemplary embodiments, the apparatus 130 may monitor the content of the database 120 continuously to determine estimation in accordance with the disclosed subject matter. In another exemplary embodiment, the apparatus 130 may monitor the content of the database 120 upon request from a client 140, in predetermined times, such as for example at an end of a month, a specific time of a day, a month or a year, and the like. In some exemplary embodiments, the apparatus 130 may perform an initial inspection of historic data records, such as for example all data records in the database 120, all records relating to a predetermined time window retained in the database 120, and the like. In some exemplary embodiments, the historic data records may be retrained in an historical database (not shown). The initial inspection may enable the server 130 to build a statistical model useful for estimation in accordance with the disclosed subject matter.

In some exemplary embodiments, the client 140 of the apparatus 130 may utilize a Man Machine Interface (MMI) 145, such as a terminal, a display, a keyboard, an input device or the like. The client 140 may determine a course of action based on the prediction of the apparatus 130. The client 140 may provide the apparatus 130 with training data, validating data, parameters, attributes or the like useful in the improvement of the statistical model. The client 140 may provide parameters, commands, and rules to be used for the estimation. The client 140 may define how the estimated value is determined. For example, the client 140 may determine that the value should take into account the cost of acquiring a non-customer, an estimated revenue generated by the non-customer (e.g., call volume, cross-network call volume, Average Revenue Per User (ARPU) value, or the like), an estimated revenue generated by the social network of the non-customer, or the like.

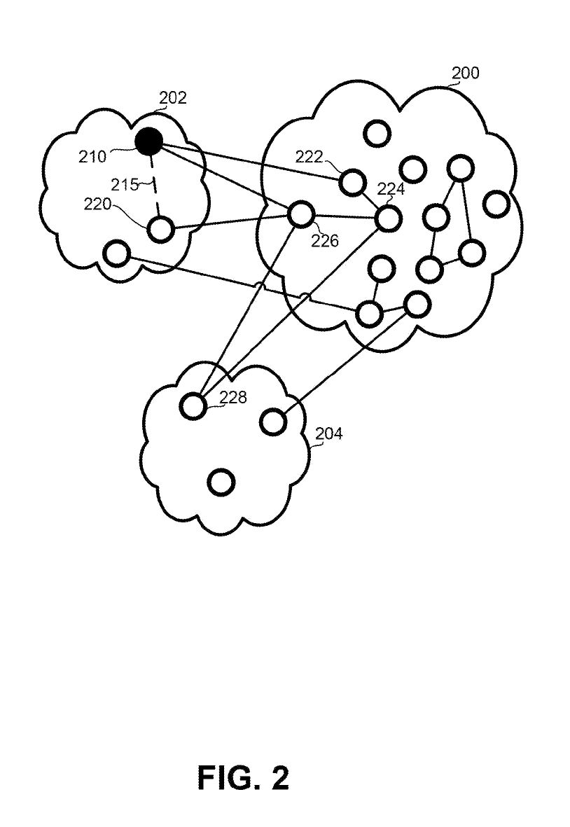

Referring now to FIG. 2 showing a diagram of interaction between various service providers' users, in accordance with some exemplary embodiments of the disclosed subject matter.

Customers of a service provider, such as 110 of FIG. 1, are depicted in group 200. Non-customers are also depicted in groups 202 and 204. Each group may be associated with a different alternative service provider.

A node, such as 222, illustrates a user (be it a customer 222 or a non-customer 210). An edge between two nodes illustrates social proximity. The social proximity may be an amount of interaction above a predetermined threshold (e.g., above a predetermined volume of calls in a time period, above a predetermined frequency of interactions, interaction above a predetermined percentile, or the like). Additional social interactions measurements are described in U.S. patent application Ser. No. 12/494,314 entitled “STATISTICAL ANALYSIS OF DATA RECORDS FOR AUTOMATIC DETERMINATION OF SOCIAL REFERENCE GROUPS”, filed Jun. 30, 2009, which is hereby incorporated by reference. The edges may be determined based on data records of the service provider. Therefore, interactions between two non-customers, such as edge 215, may not be available.

In accordance with the disclosed subject matter, based on the partial information available in regards to the non-customer 210, a social network of the non-customer 210 may be determined. The social network may comprise the users 210, 220, 222, 224, 226, and 228. As can be appreciated, without having the knowledge of the edge 215, the two non-customers 210 and 220 are determined to be socially connected. In addition, the non-customer 228 is also determined to be socially connected to the non-customer 210.

A social network may comprise of users that interact with each other. The social network may be a Strongly Connected Component in the graph depicted in FIG. 2. Users that share a social network are said to be socially proximate.

In some exemplary embodiments, based on the social analysis of a non-customer, such as 220, an estimation as to the value of the non-customer may be determined. For example, in case the non-customer 220 has high volume cross-network interactions, it may induce that if the non-customer 210 becomes a customer, the non-customer 220 may have a high volume interaction with it. Also, in case the average ARPU in respect to customers of the social network is relatively high, it may be induced that socially proximate users, such as the non-customer 220, may also be likely to have a similarly relatively high ARPU.

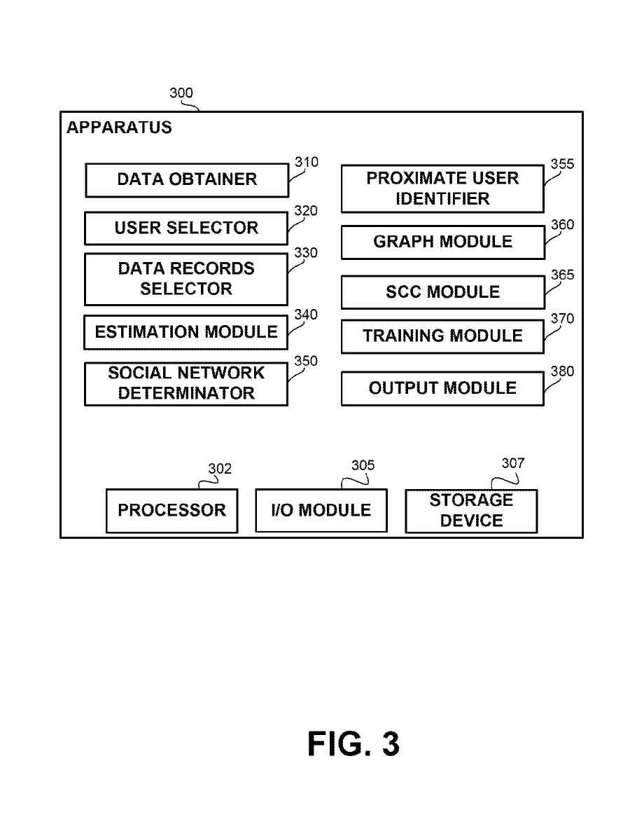

Referring now to FIG. 3 showing a block diagram of an apparatus, in accordance with some exemplary embodiments of the disclosed subject matter.

In some exemplary embodiments, a data obtainer 310 may be configured to retrieve, receive, or otherwise obtain data records of the service provider. The data records may be CDRs. The data records may be obtained from a database, such as 120 of FIG. 1. In some exemplary embodiments, the data obtainer 310 may utilize an I/O module 305 to obtain the data records. The data records may be indicative of interactions in which customers of the service provider participated. The data records, therefore, do not provide full information as to the interactions of non-customers, such as 210 of FIG. 2. In some exemplary embodiments, the data records may be data records of a predetermined time window, such as the last three months.

It will be noted that a data record may reflect an interaction which may involve at least two users. For simplicity, the detailed description focuses on interaction with two users. However, the disclosed subject matter is not limited to such interactions and interaction with three users or more may also be introduced.

In some exemplary embodiments, a user selector 320 may be configured to select a user to analyze. The user may be a non-customer. The user selector 320 may be configured to select the user based on indications from a client, such as 140 of FIG. 1. The user selector 320 may select the user from a list of potential customers. The user selector 320 may select the user based on an indication provided from a sales division or a similar entity, indicating that the user is interested in becoming a customer of the service provider. In some exemplary embodiments, the apparatus 300 may be configured to provide an estimate as to the value of acquiring the selected user. The value may be useful for cost-benefit analysis.

In some exemplary embodiments, a data records selector 330 may be configured to filter out irrelevant data records. The data records selector 330 may be configured to select a portion of the data records associated with the selected user. Data records associated with the selected user may be records which describe an interaction between users that are socially proximate to the selected user. In some exemplary embodiments, a connectivity graph may be determined in which nodes are users and edges are indication to a data record describing an interaction between the users. Any edge which is reachable from the node representing the selected user may be deemed as associated with the selected user. In some exemplary embodiments, a similar analysis may be performed in respect to social connectivity graph. In some exemplary embodiments, a data record that describes an interaction of a user that is socially proximate to the selected user may be deemed as associated with the selected user.

In some exemplary embodiments, an estimation module 340 may be operative to determine an estimated value of acquiring the selected user as a customer. The estimation module 340 may utilize a statistical model, such as built by a training module 370. The estimation module 340 may use the data records obtained by the data obtainer 310 which are associated with the selected user. In some exemplary embodiments, the estimation module 340 may take into account only filtered data records, selected by the data records selector 330.

In some exemplary embodiments, the estimation module 340 (and the statistical model that it utilizes) may be operative to estimate target properties useful for determining the estimated value. For example, the target properties may include individual properties and/or social properties of the selected user. The target properties may include: revenue generated by the selected user (e.g. call volume, cross-network call volume, or an aggregate of these representing his ARPU value), value that may be generated by his social vicinity (e.g. potential revenue generated by his close social vicinity, or by the social vicinity he is likely to bring if he is acquired), likelihood and cost of acquisition, a number of customers that belong to a competitor that the client will bring with him, and the like. In some exemplary embodiments, the target properties may be used to compute a single estimated value, such as for example by adding value generated by the selected user with the value generated by his social vicinity, and subtracting a cost of acquisition. Other formulas may be used, as to provide for useful results.

In some exemplary embodiments, the estimation module 340 (and the statistical model it utilizes) may be operative to take into account various types of information. In some exemplary embodiments, the selected user's information may be taken into account. The selected user's information may include, for example, the interaction volume (e.g., call volume, SMS volume, mailing volume, combination thereof, or the like) of the selected user with the service provider's customers, the number of such interactions that were initiated by the selected user, the number of such interactions that were not initiated by the selected user, and the number of unique individuals with which the selected user has interactions amongst the customers of the service provider. In some exemplary embodiments, information regarding users that are socially proximate to the selected user may be taken into account. These may include such parameters as, for example, the number of directly linked users the selected user has, how many of them are customers, their demographics. Similar information may be taken into account in respect to the users from the selected user's social network. As users may tend to be similar to users who are socially similar to them, the social network of the selected user may be an indicative reference group. For example, average ARPU of the customers who are socially proximate to the selected user may be used as indicative of the selected user's expected ARPU. In some exemplary embodiments, social criteria may be taken into account. The selected user's social activity and vicinity may be taken into account. These may include an estimation of the mean activity of the socially proximate non-customers of the selected user (i.e., users who are socially proximate to the selected user and who are too not customers of the service provider, such as 220 and 228 of FIG. 2). The above attributes are provided as an example only, and other attributes may be used.

In some exemplary embodiments, a social network determinator 350 may be operative to build a social network of the selected user based on the data records. The social network may be stored in a computer readable medium, such as a storage device 307.

In some exemplary embodiments, a proximate user identifier 355 may be operative to identify users that are socially proximate to the selected user, based on the social network. In some exemplary embodiments, the proximate user identifier 355 may determine, in a graph representation of the social network, all nodes that are connected, either directly or indirectly, to the node associated with the selected user.

In some exemplary embodiments, a graph module 360 may be operative to generate a graph representation of connectivity between users. The graph may comprise nodes associated with users. An edge in the graph may be representative of an interaction between the users. In some exemplary embodiments, the edge may be representative of an interaction of a minimal threshold degree. An edge may, therefore, indicate of a social connectivity between the two users. The edges may be weighted where the weight may be indicative of an intensity of the interaction. For example, a larger call volume may induce a larger number as a weight. In some exemplary embodiments, the graph may be indicative of an interaction in a predetermined time window, such as in the last three months. Thus, obsolete social connections such as people who are no longer in a romantic relationship, former colleagues, or the like, may not be taken into account. In some exemplary embodiments, the graph may be retained in a computer readable medium such as the storage device 307.

In some exemplary embodiments, a Strongly Connected Component (SCC) module 365 may be operative to identify in the graph. The SCC may be a social network. In some exemplary embodiments, the SCC module 365 may partition the graph into SCCs. The SCC that comprises the node of the selected user may be taken into account by the estimation module 340.

In some exemplary embodiments, a training module 370 may be operative to build a statistical model based on training data. The training data may be historic data, and corresponding results data (e.g., historic CDRs and values of non-customers in the CDRs that were acquired shortly after). The training data may be a portion of the data records of the service provider that provide for a partial view in respect to a one or more customers. The partial view may treat the customers as non-customers by dropping any data (e.g., CDRs) that are associated with those customers and non-customers. Referring to FIG. 2, a partial view in respect to customer 226 may drop the edges between the customer 226 and the non-customers 210, 220 and 228 but retain the edge between the customer 226 and other customer 224, thus providing for a simulation of partial data regarding the customer 226 as if it was a non-customer. By using the partial view and using the full view to determine the correct expected results, the statistical model may be trained. In some exemplary embodiments, the training module 370 may use a different partial view of the data records: data in respect to interactions between customers are dropped, leaving only data regarding interaction between a customer and one or more non-customers. This data may reflect the service provider's data on the non-customers. The model may be fully validated using the service provider's full data records. In some exemplary embodiments, the training module 370 may train and validate the model on a population of users that joined the service provider, comparing their predicted properties which are based on data before joining in with their measured properties after joining.

In some exemplary embodiments, training the statistical model may be performed using machine learning algorithms such as Support Vector Machine (SVM), regression analysis, nearest neighbor analysis, and the like. In some exemplary embodiments, the training module 370 may be responsive to actual results which may be measured and used for validation of the statistical model. In response to actual results, the statistical model may be validated or modified to increase its effectiveness.

In some exemplary embodiments, an output module 380 may be operative to provide a list of users having a relatively high estimated value. In some exemplary embodiments, the apparatus 300 may be utilized in respect to a plurality of users, each time determining an estimated value for each user.

The list of users may be provided using the output module 380 to a client, such as 140 of FIG. 1, to enable better marketing resource allocation. The list may be sorted so that the non-customers having the highest estimated value appear first. The list may include only non-customers having an estimated value above a predetermined threshold. In some exemplary embodiments, a list of the prospective clients may be generated. In this list, users are ranked according to their estimated value. The value model may take into account and combine the estimated individual properties of the user (such as its estimated activity and revenue), with social properties (such that the revenue expected from bringing some of the user's friends into the network).

In some exemplary embodiments, the apparatus 300 may comprise a processor 302. The processor 302 may be a Central Processing Unit (CPU), a microprocessor, an electronic circuit, an Integrated Circuit (IC) or the like. The processor 302 may be utilized to perform computations required by the apparatus 300 or any of it subcomponents.

In some exemplary embodiments of the disclosed subject matter, the apparatus 300 may comprise an Input/Output (I/O) module 305. The I/O module 305 may be utilized to provide an output to and receive input from a client, such as 140 of FIG. 1.

In some exemplary embodiments, the apparatus 300 may comprise a storage device 307. The storage device 307 may be a hard disk drive, a Flash disk, a Random Access Memory (ROM), a memory chip, or the like. In some exemplary embodiments, the storage device 307 may retain program code operative to cause the processor 302 to perform acts associated with any of the subcomponents of the apparatus 300.

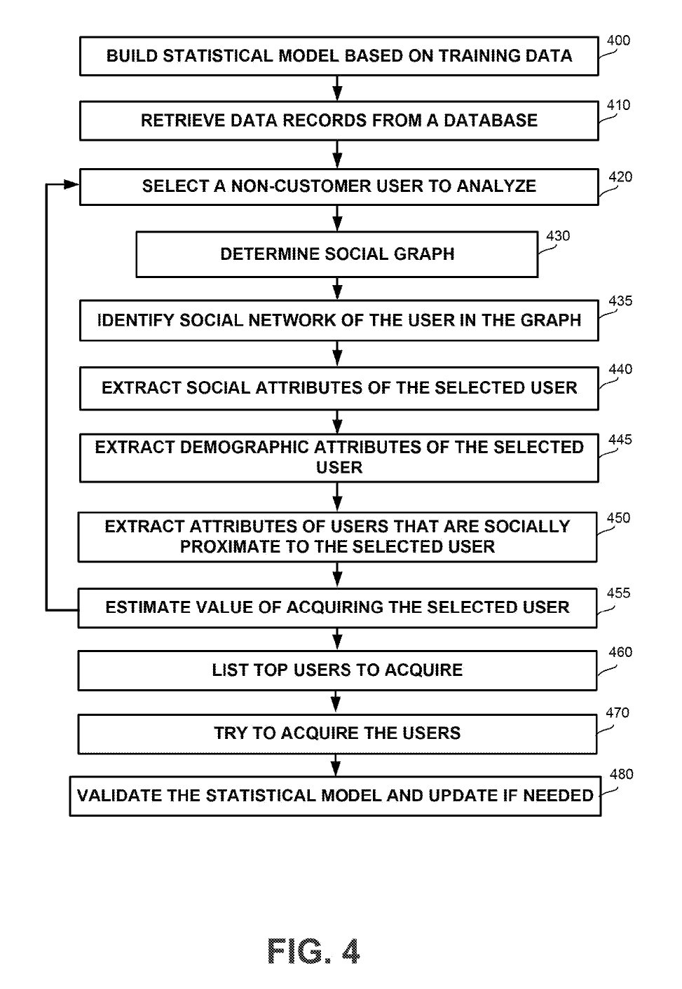

Referring now to FIG. 4 showing a flowchart diagram of a method in accordance with some exemplary embodiments of the disclosed subject matter.

In step 400, a statistical model may be built based on training data. The statistical model may be built by a training module, such as 370 of FIG. 3.

In step 410, data records may be retrieved. The data records may be retrieved from a database, such as 120 of FIG. 1. The data records may be retrieved by a data obtainer, such as 310 of FIG. 3.

In step 420, a non-customer user may be selected to be analyzed. The non-customer may be selected by a user selector, such as 320 of FIG. 3. In some exemplary embodiments, the non-customer may be selected based on an indication that the non-customer is interesting in migrating to the service provider and the non-customer's estimated value may be used to determine a service deal to offer the non-customer.

In step 430, a social graph may be determined. The social graph may be determined by a graph module, such as 360 of FIG. 3, and/or a social network determinator, such as 350 of FIG. 3.

In step 435, a social network of the user may be identified. The social network may be an SCC identified by an SCC module, such as 365 of FIG. 3.

In step 440, based on the social network, social attributes of the user may be extracted. The social attributes may be extracted by an estimation module, such as 340 of FIG. 3.

In step 445, demographic attributes of the user may be extracted. The demographic attributes may be extracted by the estimation module. The demographic attributes may be extracted from data records. The demographic attributes may be received from a client, such as 140 of FIG. 1.

In step 450, attributes of users that are socially proximate to the selected user may be extracted. The attributes may be extracted by the estimation module.

In step 455, an estimated value of acquiring the selected user may be determined. The estimated value may be based on a set of target properties estimated by the statistical model. The estimated valued may be determined by the estimation module.

In some exemplary embodiments, additional users may be analyzed in steps 420-455.

In step 460, list of “top” users to acquire may be generated. The list may comprise users with estimated value above a predetermined value. The list may be sorted based on the estimated value in a descending order. The list may be generated and provided to a client by an output module, such as 380 of FIG. 3.

In step 470, there may be an attempt to acquire the users in the list. A marketing division, a sales representative or the like, may contact the users in the list and offer them a relatively attractive offer so that when taken in consideration with the estimated value, the service provider will generate positive revenue from acquiring the user.

In step 480, and in response to acquiring a user, the statistical model may be validated or updated, by comparing actual value and expected value. The statistical model may be validated by the training module.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method, or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, the method comprising:
obtaining data records from a service provider, each data record is indicative of an interaction between at least two users, wherein at least one of the at least two users is a customer of the service provider;
selecting a user, the user is a customer of an alternative service provider; and
estimating, based on a portion of the data records that is associated with the selected user and based on a statistical model, an estimated value of an activity-related parameter associated with the selected user.

2. The computer-implemented method of claim 1, wherein the data records further comprise additional information selected from the group consisting of billing information and demographic information.

3. The computer-implemented method of claim 1, wherein said estimating is further performed based on a social analysis of the selected user social proximate users.

4. The computer-implemented method of claim 1, wherein said estimating further comprises:
building a social network of the selected user based on the data records; and
extracting a social attribute of the selected user from the social network.

5. The computer-implemented method of claim 4, wherein said building comprises:
generating a graph comprising of nodes and edges, wherein a node is representative of a user, wherein an edge is representative of a social connectivity between two users;
identifying in the graph a Strongly Connected Component (SCC) comprising the selected user; and
determining the social network as comprising the users of the SCC.

6. The computer-implemented method of claim 5, wherein the graph is a weighted graph, and wherein a weight of an edge is indicative of an intensity of the social connectivity.

7. The computer-implemented method of claim 4, wherein the social attribute is indicative of activity in respect to the social network.

8. The computer-implemented method of claim 4, wherein the social attribute is indicative of a social activity of a second user, the second user is socially proximate to the selected user, the second user is not a customer of the service provider.

9. The computer-implemented method of claim 1, wherein said estimating is performed based on at least one of the following attributes:
a descriptive information of the selected user;
a social attribute of the selected user; and
information about socially proximate users.

10. The computer-implemented method of claim 1, further comprising:
obtaining training data; and
building the statistical model based on the training data.

11. The computer-implemented method of claim 1, wherein the training data comprises a partial view of data records of the service provider, wherein the partial view is a view in which a set of customers of the service provider are treated as non-customers.

12. The computer-implemented method of claim 1, wherein the activity-related parameter is an estimated value of acquiring the selected user as a customer of the service provider.

13. The computer-implemented method of claim 12, further comprising:
acquiring the selected user;
measuring actual value of the selected user; and
validating the statistical model.

14. The computer-implemented method of claim 12, wherein the method is performed in respect to a plurality of selected users, and indicating a portion of the plurality of selected users to be acquired.

15. The computer-implemented method of claim 12, wherein the selected user is a user which is indicated has having an interest in becoming a customer of the service provider.

16. The computer-implemented method of claim 12, wherein said estimating comprises estimating a set of properties, the set of properties are selected from a group consisting of a revenue generated by the selected user, a potential value to be generated by users that are socially proximate to the selected user, a likelihood of acquisition of the selected user, and a cost of acquisition of the selected user.

17. The computer-implemented method of claim 1, wherein the portion of the data records that is associated with the selected user comprises data records in which at least one user is comprised by a social network of the selected user.

18. A computerized apparatus having a processor and a memory device, the computerized system comprising:
a data obtainer operative to obtain data records, each data record is indicative of an interaction between at least two users, wherein at least one of the at least two users is a customer of the service provider;
a user selector operative to select a user, the selected user is a customer of an alternative service provider; and
an estimation module operative to estimate, based on a portion of the data records that is associated with the user and based on a statistical model, an estimated value of an activity-related parameter associated with the selected user.

19. The computerized apparatus of claim 18, wherein said estimation module is operative to estimate the value based on a social analysis of the selected user.

20. The computerized apparatus of claim 18, further comprising: a social network determinator operative to build a social network of the selected user based on the data records.

21. The computerized apparatus of claim 20, further comprising a proximate user identifier operative to identify users that are socially proximate to the selected user based on the social network.

22. The computerized apparatus of claim 20, further comprising:
a graph module operative to generate a graph comprising of nodes and weighted edges, wherein a node is representative of a user, wherein an edge is representative of an interaction between two users; and
a Strongly Connected Component (SCC) module operative to identify an SCC in the graph.

23. The computerized apparatus of claim 18, further comprising a training module operative to build a statistical model based on training data.

24. The computerized apparatus of claim 18, wherein the estimated value is an estimated value of acquiring the selected user as a customer of the service provider; and the apparatus further comprising an output module operative to provide a list of users, the list of users comprises user's having the highest estimated value, as determined by said estimation module.

25. A computer program product comprising:
a non-transitory computer readable medium;
a first program instruction for obtaining data records from a service provider, each data record is indicative of an interaction between at least two users, wherein at least one of the at least two users is a customer of the service provider;
a second program instruction for selecting a user, the user is a customer of an alternative service provider;
a third program instruction for estimating, based on a portion of the data records that is associated with the selected user and based on a statistical model, an estimated value of an activity-related parameter associated with the selected user; and
wherein said first, second, and third program instructions are stored on said non-transitory computer readable media.
